(19) United States
(12) Patent Application Publication
(10) Pub. No.: US 2008/0117970 A1
(43) Pub. Date: May 22, 2008

(54) METHOD AND APPARATUS FOR ENCODING AND DECODING RGB IMAGE

(75) Inventor: Byung-cheol SONG, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 11/858,504

(22) Filed: Sep. 20, 2007

(30) Foreign Application Priority Data
Nov. 20, 2006 (KR) 10-2006-0114727

(51) Int. Cl. H04N 7/12

(52) U.S. Cl. 375/240.13; 375/E07.243

(57) ABSTRACT

Provided are an apparatus and method for encoding and decoding an RGB image without color format conversion. The RGB image encoding method includes storing an RGB image and performing RGB-encoding on the stored RGB image, wherein the RGB encoding comprises performing intra prediction or inter prediction for encoding a current image on the basis of a previous RGB image. The apparatus includes an RGB decoding unit and an RGB image storage unit, which decoded and store RGB images, respectively, and inter/intra prediction unit performing inter-prediction or intra-prediction.

### CROSS-REFERENCE TO RELATED PATENT APPLICATION

This application claims priority from Korean Patent Application No. 10-2006-0114727, filed on Nov. 20, 2006, in the Korean Intellectual Property Office, the disclosure of which is incorporated herein in its entirety by reference.

### BACKGROUND OF THE INVENTION

1. Field of the Invention

Methods and apparatuses consistent with the present invention relate to encoding and decoding of red, green, blue (RGB) images, and more particularly, to encoding and decoding images without converting between RGB images and YCbCr images.

2. Description of the Related Art

Moving-picture codecs which are adopted in the majority of existing digital audio/visual (AV) systems are based on YCbCr images. Accordingly, although image information captured by a camera is based on RGB images, considering that compressibility is improved when image information is compressed to YCbCr images, RGB images are converted into YCbCr images and the YCbCr images are compressed. Accordingly, when decoding is performed, YCbCr images must be converted back into RGB images.

FIG. 1 is a block diagram of a related art YCbCr-based moving-picture codec system.

Referring to FIG. 1, the related art YCbCr-based moving-picture codec system includes an encoding apparatus 120 and a decoding apparatus 140. The encoding apparatus 120 includes a first format conversion unit 122, a sub-sampler 124, and a YCbCr encoding unit 126.

The first format conversion unit 122 converts a received RGB image into a YCbCr image. If a codec having a 4:2:0 format is adopted, the sub-sampler 124 converts a YCbCr image with a 4:4:4 format into a YCbCr image with a 4:2:0 format. The YCbCr encoding unit 126 encodes the YCbCr image with the 4:2:0 format received from the sub-sampler 124. The YCbCr encoding unit 126 may be a Moving Pictures Experts Group (MPEG) 2-based or H.264-based encoder.

The decoding apparatus 140 includes a YCbCr decoding unit 142, an up sampler 144, and a second format converter 146.

The YCbCr decoding unit 142 decodes a received stream and outputs a decoded YCbCr image. The YCbCr decoding unit 142 may be an MPEG 2-based or H.264-based decoder. If the decoded YCbCr image is a YCbCr image with a 4:2:0 format, the decoded YCbCr image is converted into a YCbCr image with a 4:4:4 format. The second format converter 446 converts the YCbCr image with the 4:4:4 format into a RGB image with a 4:4:4 format and outputs the RGB image with the 4:4:4 format to a display unit (not shown).

As such, since the related art moving-picture codec is based on YCbCr images, RGB images must be converted into YCbCr images and accordingly the number of calculations for conversion is increased. Also, when RGB images are converted into YCbCr images and the YCbCr images are encoded, high quality images cannot be provided.

### SUMMARY OF THE INVENTION

Exemplary embodiments of the present invention overcome the disadvantages described above and other disadvantages not described above. Also, the present invention is not required to overcome the disadvantages described above, and an exemplary embodiment of the present invention may not overcome any of the problems described above.

The present invention provides an RGB-based moving-image encoding and decoding method.

According to an aspect of the present invention, there is provided a method of encoding an RGB image, the method including: receiving and storing the RGB image; and performing RGB-encoding on the RGB image, wherein the RGB-encoding comprises performing intra prediction or inter prediction for encoding a current image on the basis of a previous RGB image.

The RGB-encoding of the RGB image includes: mixing a first RGB image with a second RGB image which is different from the first RGB image and generating a mixed RGB image; and performing RGB-encoding on the mixed RGB image, wherein the RGB-encoding comprises performing the intra prediction or inter prediction for encoding the current image on the basis of the previous RGB image.

The first RGB image may be an analog RGB image or a digital RGB image, and the second RGB image may be an On Screen Display (OSD) image.

The method further includes: storing the first RGB image; storing the second RGB image; and storing the mixed RGB image.

The mixing of the first RGB image with the second RGB image is performed according to the equation

R_{f}=α×r₁+(1−α)×r₂

G_{f}=α×g₁+(1−α)×g₂

B_{f}=α×b₁+(1−α)×b₂

where R_{f}, G_{f}, and B_{f} are red (R), green (G), and blue (B) signals of a final RGB signal, respectively, r₁, gᵢ, and b₁ are R, G, and B signals at arbitrary locations in the first RGB signal, respectively, and r₂, g₂, and b₂ are R, G, and B signals at locations corresponding to locations of the r₁, g₁, and b₁ of the first RGB signal in the second RGB signal, respectively.

According to another aspect of the present invention, there is provided an apparatus for encoding an RGB image, including: a storage unit storing an input RGB image; and an RGB encoding unit performing RGB encoding on the stored RGB image, wherein the RGB encoding unit comprises an inter and intra prediction unit performing inter prediction and intra prediction for encoding a current image on the basis of a previous RGB image.

According to another aspect of the present invention, there is provided an encoding apparatus for encoding an RGB image, including: a mixing unit mixing an input first RGB image with a second RGB image which is different from the first RGB image; and an RGB encoding unit encoding the mixed RGB image, wherein the RGB encoding unit comprises an inter and intra prediction unit performing inter prediction or intra prediction for encoding a current image on the basis of a previous RGB image.

According to another aspect of the present invention, there is provided a method of decoding an RGB image, including: receiving an encoded RGB image; decoding the received RGB image; storing the decoded RGB image; and performing inter prediction or intra prediction for decoding a current image on the basis of a decoded previous RGB image.

According to another aspect of the present invention, there is provided a method of decoding an RGB image, including: receiving an encoded RGB image generated by encoding an RGB image in which a first RGB image is mixed with a second RGB image which is different from the first RGB image; decoding the encoded RGB image; storing the decoded RGB image; and performing inter prediction or intra prediction for decoding a current image on the basis of a decoded previous RGB image.

According to another aspect of the present invention, there is provided an apparatus for decoding an RGB image, including: an input unit receiving an encoded RGB image; an RGB decoding unit decoding the received RGB image; an RGB image storage unit storing the decoded RGB image; and an inter and intra prediction unit performing inter prediction or intra prediction for decoding a current image on the basis of a decoded previous RGB image.

According to another aspect of the present invention, there is provided an apparatus for decoding an RGB image, including: an input unit receiving an encoded RGB image generated by encoding an RGB image in which a first RGB image is mixed with a second RGB image which is different from the first RGB image; and

an RGB decoding unit decoding the received RGB image, wherein the RGB decoding unit comprises an RGB image storage unit storing the decoded RGB image; and an inter and intra prediction unit performing inter prediction or intra prediction for decoding a current image on the basis of a decoded previous RGB image.

According to another aspect of the present invention, there is provided a computer-readable recording medium having embodied thereon a program for executing an RGB image encoding method, the method including: receiving and storing an RGB image; and performing RGB-encoding on the RGB image, wherein the RGB-encoding of the RGB image comprises performing intra prediction or inter prediction for encoding a current image on the basis of a previous RGB image.

According to another aspect of the present invention, there is provided a computer-readable recording medium having embodied thereon a program for executing an RGB image encoding method, the method including: receiving a first RGB image, mixing the first RGB image with a second RGB image which is different from the first RGB image, and generating a mixed RGB image; and performing RGB-encoding on the mixed RGB image, wherein the RGB-encoding of the mixed RGB image comprises performing intra prediction or inter prediction for encoding a current image on the basis of a previous RGB image.

According to another aspect of the present invention, there is provided a computer-readable recording medium having embodied thereon a program for executing an RGB image decoding method including: receiving an encoded RGB image; decoding the RGB image; storing the decoded RGB image; and performing inter prediction or intra prediction for decoding a current image on the basis of a decoded previous RGB image.

According to another aspect of the present invention, there is provided a computer-readable recording medium having embodied thereon a program for executing an RGB image decoding method, the method including: receiving an encoded RGB image generated by encoding an RGB image in which a first RGB image is mixed with a second RGB image which is different from the first RGB image; decoding the encoded RGB image; storing the decoded RGB image; and performing inter prediction or intra prediction for decoding a current image on the basis of a decoded previous RGB image.

### BRIEF DESCRIPTION OF THE DRAWINGS

The above and other aspects of the present invention will become more apparent by describing in detail exemplary embodiments thereof with reference to the attached drawings in which:

FIG. 1 is a block diagram illustrating a related art YCbCr encoding apparatus;

FIG. 2 is a block diagram illustrating an RGB image encoding apparatus according to an exemplary embodiment of the present invention;

FIG. 3 is a block diagram illustrating an RGB encoding unit illustrated in FIG. 2;

FIG. 4 is a flowchart illustrating an RGB image encoding method according to an exemplary embodiment of the present invention;

FIG. 5 is a block diagram illustrating an RGB image decoding apparatus according to an exemplary embodiment of the present invention;

FIG. 6 is a block diagram illustrating an RGB decoding unit illustrated in FIG. 5;

FIG. 7 is a flowchart illustrating an RGB image decoding method according to an exemplary embodiment of the present invention;

FIG. 8 is a block diagram illustrating an RGB image encoding apparatus according to another exemplary embodiment of the present invention;

FIG. 9 is a flowchart illustrating an RGB image encoding method according to another exemplary embodiment of the present invention; and

FIG. 10 is a flowchart illustrating an RGB image decoding method according to another exemplary embodiment of the present invention.

### DETAILED DESCRIPTION OF THE EXEMPLARY EMBODIMENTS

Hereinafter, embodiments of the present invention will be described in detail with reference to the appended drawings.

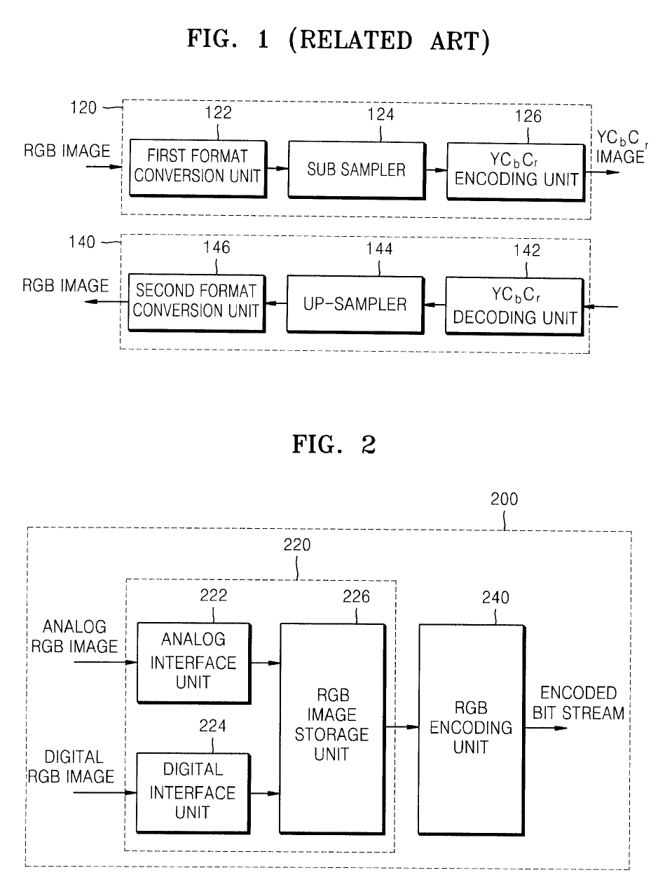

FIG. 2 is a block diagram illustrating an RGB image encoding apparatus 200 according to an exemplary embodiment of the present invention.

Referring to FIG. 2, the RGB image encoding apparatus 200 includes an RGB encoding unit 240, and an RGB image input and storage unit 220 including an analog interface unit 222, a digital interface unit 224, and an RGB image storage unit 226.

The analog interface unit 222 receives an analog RGB image and outputs the analog RGB image to the RGB image storage unit 226. The analog RGB image may be, for example, but not limited to, composite video, component video, video S-video, or VESA video.

The digital interface unit 224 receives a digital RGB image and outputs the digital RGB image to the RGB image storage unit 226. The digital RGB image may be, for example, but not limited to, a High Definition Multimedia Interface (HDMI) image, a Transition Minimized Differential Signaling (TMDS) image, or a Low Voltage Differential Signaling (LVDS) image.

The RGB storage unit 226 stores the analog RGB image or the digital RGB image output from the analog interface unit 222 and the digital interface unit 224. The RGB storage unit 226 may be, for example, but not limited to, a synchronous dynamic random access memory (SDRAM), a double data rate SDRAM (DDR SDRAM), a double data rate 2 SDRAM (DDR2 SDRAM), a static random access memory (SRAM), or a volatile memory device such as a register. Also, the RGB storage unit 226 may be a non-volatile memory device, for example, but not limited to, a hard disc or a flash memory. The RGB storage unit 226 outputs the stored analog RGB image or digital RGB image to the RGB encoding unit 240.

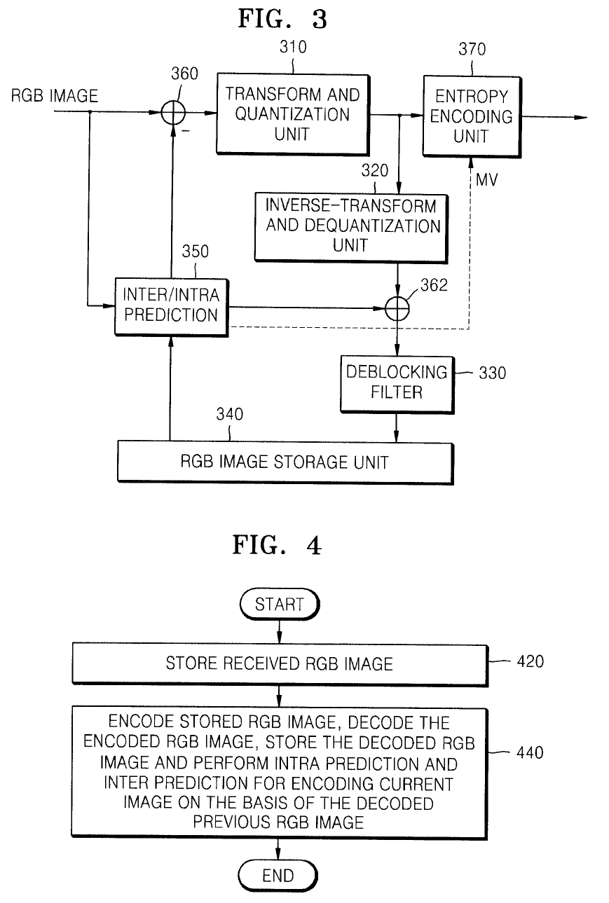

The RGB encoding unit 240 encodes the analog RGB image or the digital RGB image, and outputs an encoded bit stream. The RGB encoding unit 240 will be described in more detail later with reference to FIG. 3.

FIG. 3 is a block diagram illustrating the RGB encoding unit 240 illustrated in FIG. 2.

Referring to FIG. 3, the RGB encoding unit 240 includes a transform and quantization unit 310, an inverse-transform and de-quantization unit 320, a de-blocking filter 330, an RGB storage unit 340, an inter/intra prediction unit 350, a first adder 360, a second adder 362, and an entropy encoding unit 370.

The transform and quantization unit 310 transforms input image data in order to remove spatial redundancy of image data. Also, transform coefficient values obtained by transforming and encoding the image data are quantized according to a predetermined quantization method so that N×M data, which is two-dimensional data consisting of the quantized transform coefficient values, is obtained. The predetermined quantization method may be, for example, but not limited to, Discrete Cosine Transformation (DCT). The quantization is performed according to the predetermined quantization method.

The inverse-transform and de-quantization unit 320 de-quantizes image data quantized by the transform and quantization unit 310, and performs inverse-transformation (that is, for example, but not limited to, inverse-DCT) on the de-quantized image data.

The second adder 362 adds a prediction image output from the inter/intra prediction unit 350 with data restored by the inverse-transform and de-quantization unit 320, and generates a restored image.

The de-blocking filter 330 performs filtering and outputs the result to the RGB storage unit 340, in order to remove a blocking phenomenon caused by quantization from the restored image generated by the second adder 362. If desired, the de-blocking filter 330 can be omitted.

The RGB image storage unit 340 stores the image data which has been inverse-transformed and dequantized by the inverse-transform and de-quantization unit 320, or the data filtered by the de-blocking filter 330, in a unit of a frame. The RGB image storage unit 340 may be, for example, but not limited to, a SDRAM, a DDR SDRAM, a DDR2 SDRAM, a SRAM, or a volatile memory device such as a register. The restored RGB image stored in the RGB image storage unit 340 is delayed by a predetermined time and then output and used for inter prediction and intra prediction.

The inter/intra prediction unit 350 includes an intra prediction unit and a motion prediction unit and compensation unit (not shown).

In the case of an intra macroblock, the intra prediction unit obtains a predictor for each block or for each macro block in a spatial area and outputs the predictor to the adder 360.

The motion prediction and compensation unit predicts a motion vector MV for each macroblock, using image data of a current input frame and image data of the previous frame stored in the RGB image storage unit 340. Also, a prediction area P motion-compensated on the basis of the predicted motion vector MV, for example, a 16×16 area selected by motion prediction is generated and output to the adder 360. The RGB encoding unit 240 selects one of an inter mode or an intra mode in a unit of a predetermined block, for example, in a unit of a macroblock.

The adder 360 transmits difference information between the original RGB image and the predictor output from the inter/intra prediction unit 350, to the transform and quantization unit 310, in a unit of a predetermined block.

The entropy encoding unit 370 receives information about the motion vector MV output from the motion prediction and compensation unit and the quantized transform coefficients output from the transform and quantization unit 310, entropy-encodes the information, and outputs an encoded bit stream.

FIG. 4 is a flowchart illustrating an RGB image encoding method according to an exemplary embodiment of the present invention, which is performed by the RGB image encoding apparatus 200 illustrated in FIG. 2.

Referring to FIG. 4, in operation 420, an input RGB image is stored. If an input RGB image is an analog RGB image, the analog RGB image is stored in the form of RGB without any format conversion, via an analog interface. Also, if the input RGB image is a digital RGB image, the digital RGB image is stored in the form of RGB without any format conversion, via a digital interface.

Then, in operation 440, the input RGB image stored in operation 420 is encoded. The encoded RGB image is decoded, the decoded RGB image is stored, and intra prediction or inter prediction for encoding a current RGB image is performed on the basis of the decoded previous RGB image.

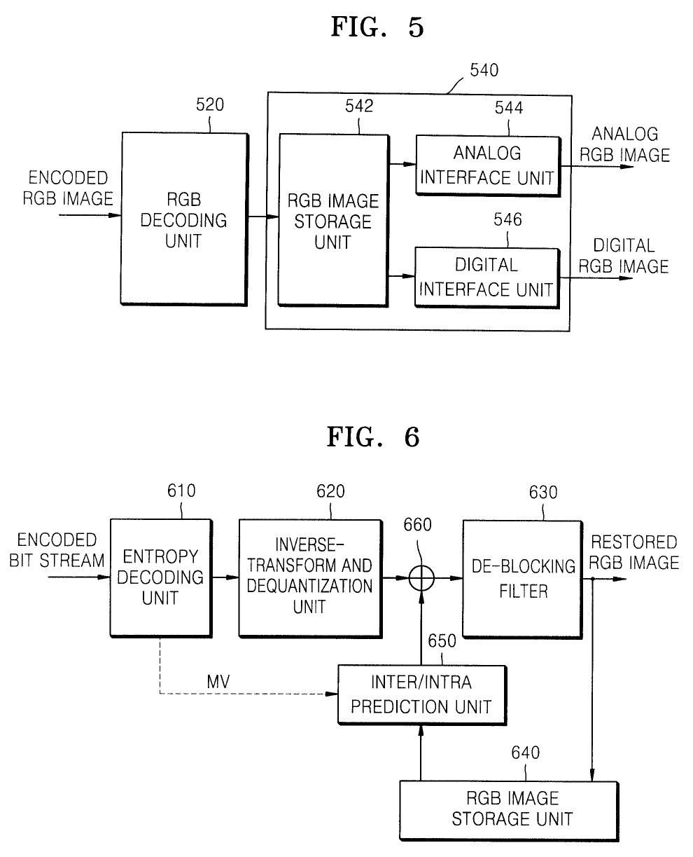

FIG. 5 is a block diagram illustrating an RGB image decoding apparatus according to an exemplary embodiment of the present invention.

Referring to FIG. 5, the RGB image decoding apparatus includes an RGB decoding unit 520, and a decoded RGB image storage and output unit 540 including an RGB storage unit 542, an analog interface unit 544, and a digital interface unit 546.

The RGB decoding unit 520 decodes and outputs an encoded stream. The RGB encoding unit 520 will be described in detail later with reference to FIG. 6.

The RGB image storage unit 542 stores the decoded RGB image output from the RGB decoding unit 520. In the exemplary embodiment, the stored RGB image is delayed by a predetermined time and then output to the analog interface 544 and the digital interface unit 546.

The RGB image storage unit 542 may be, for example, but not limited to, a SDRAM, a DDR SDRAM, a DDR2 SDRAM, a SRAM, or a volatile memory device such as a register. Also, the RGB image storage unit 542 may be, for example, but not limited to, a non-volatile memory device such as a hard disc or a flash memory. The RGB image storage unit 542 selectively outputs the stored analog RGB image or the stored digital RGB image to the analog interface unit 544 or the digital interface unit 546, respectively.

The analog interface unit 544 receives the analog RGB image and outputs the analog RGB image to a display unit (not shown). The analog RGB image may be, for example, but not limited to, a composite, a component, S-video, or VESA video.

The digital interface unit 546 receives the digital RGB image and outputs the digital RGB image to the display unit (not shown). The digital RGB image may be, for example, but not limited to, a High Definition Multimedia Interface (HDMI) image, a Transition Minimized Differential Signaling (TMDS) image, or a Low Voltage Differential Signaling (LVDS) image.

FIG. 6 is a block diagram illustrating the RGB decoding unit 520 illustrated in FIG. 5.

Referring to FIG. 6, the RGB decoding unit 520 includes an entropy decoding unit 610, an inverse-transform and de-quantization unit 620, a de-blocking filter 630, an RGB image storage unit 640, an inter/intra prediction unit 650, and an adder 660.

The entropy decoding unit 610 entropy-decodes an encoded input stream and extracts image data, a motion vector, etc. from the input stream. The entropy-decoded image data is transferred to the inverse-transform and de-quantization unit 620, and motion vector information is transferred to the inter/intra prediction unit 650.

The inverse-transform and de-quantization unit 620 performs inverse-transform and de-quantization on the image data extracted by the entropy decoding unit 610.

The de-blocking filter 630 performs filtering and outputs the result to the RGB storage unit 640 and a display unit (not shown), in order to remove a blocking phenomenon caused by quantization from a restored image generated by the second adder 660. If desired, the de-blocking filter 630 can be omitted.

The RGB image storage unit 640 stores the image data inverse-transformed and de-quantized by the inverse-transform and de-quantization unit 620 or the data filtered by the de-blocking filter 630, in a unit of a frame. The RGB image storage unit 640 may be, for example, but not limited to, an SDRAM, a DDR SDRAM, a DDR2 SDRAM, an SRAM, and a register. The restored RGB image stored in the RGB storage unit 640 is delayed by a predetermined time and then output and used for inter prediction and intra prediction.

The inter/intra prediction unit 650 includes an intra prediction unit (not shown) and a motion prediction and compensation unit (not shown).

In the case of an intra macroblock, the intra prediction unit obtains a predictor for each block or for each macroblock in a spatial area, and outputs the predictor to the adder 660. The motion prediction and compensation unit generates a predetermined prediction area P, for example, a 16×16 area selected by motion prediction, on the basis of the extracted motion vector and the previous frame image received from the RGB image storage unit 640.

The adder 660 adds the RGB image restored by the inverse-transform and de-quantization unit 620 with the predictor output from the inter/intra prediction unit 650, and outputs the RGB image and the predictor to a display unit (not shown) and the RGB image storage unit 640 or to the display unit (not shown) and the RGB image storage unit 640 via the de-blocking filter 630.

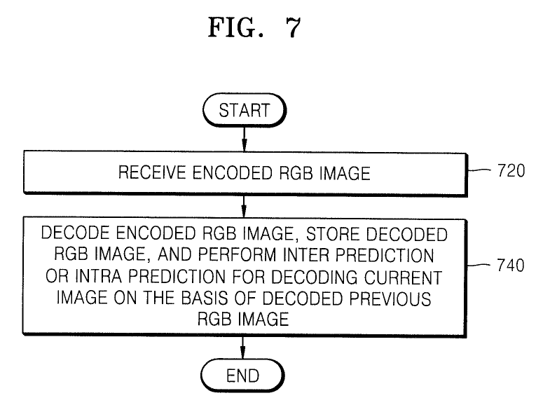

FIG. 7 is a flowchart illustrating an RGB image decoding method according to an exemplary embodiment of the present invention, which is performed by the RGB image decoding apparatus illustrated in FIG. 5.

In operation 720, an encoded RGB image is received.

In operation 740, the encoded RGB image is decoded, the decoded RGB image is stored, and inter prediction or intra prediction for decoding a current image is performed on the basis of the decoded previous RGB image. In more detail, the decoded RGB image is delayed by a predetermined time and output via an analog interface or a digital interface.

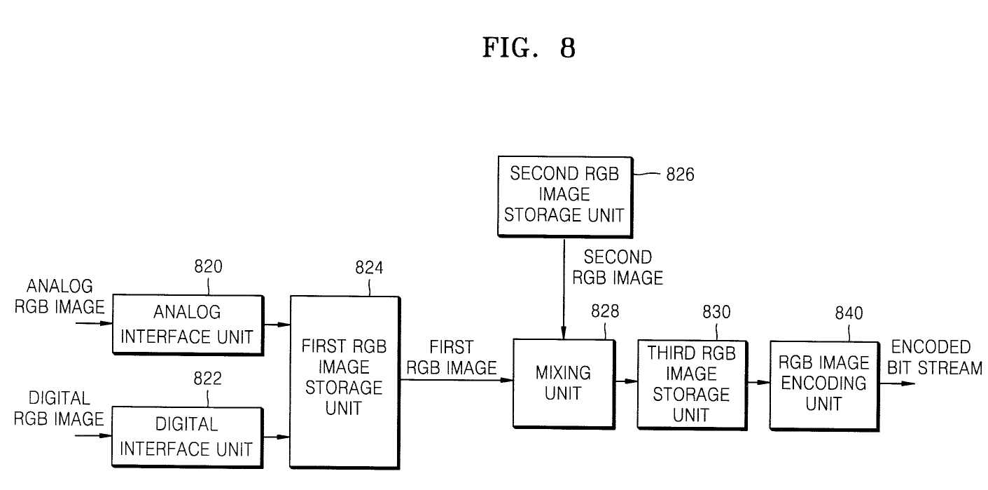

FIG. 8 is a block diagram of an RGB image encoding apparatus according to another exemplary embodiment of the present invention.

Referring to FIG. 8, the RGB image encoding apparatus includes an analog interface unit 820, a digital interface unit 822, a first RGB image storage unit 824, a second RGB image storage unit 826, a mixing unit 828, a third RGB image storage unit 830, and an RGB image encoding unit 840.

The analog interface unit 820 receives an analog RGB image and outputs the analog RGB image to the first RGB image storage unit 824. The analog RGB image may be, for example, but not limited to, composite video, component video, S-video, or VESA video.

The digital interface unit 822 receives a digital RGB image and outputs the digital RGB image to the first RGB image storage unit 824. The digital RGB image may be, for example, but not limited to, a HDMI image, a TMDS image, or a LVDS image.

The first RGB image storage unit 824 stores an analog RGB image or a digital RGB image output from the analog interface unit 820 or the digital interface unit 822, respectively. The first RGB image storage unit 824 may be, for example, but not limited to, a SDRAM, a DDR SDRAM, a DDR2 SDRAM, an SRAM, or a volatile memory such as a register. Also, the first RGB image storage unit 824 may be, for example, but not limited to, a non-volatile memory device such as a hard disc or a flash memory. The first RGB image storage unit 824 outputs the stored analog RGB image or the stored digital RGB image to the mixing unit 828.

The mixing unit 828 mixes the RGB image received from the first RGB image storage unit 824 with the second RGB image received from the second RGB image storage unit 826, and then outputs the mixed RGB image to the third RGB image storage unit 830. In the exemplary embodiment, the second RGB image received from the second RGB image storage unit 826 may be an On Screen Display (OSD) image for digital TVs (DTVs). If desired, the mixing unit 828 can receive an arbitrary RGB image.

Hereinafter, a method in which two RGB images are mixed, according to an exemplary embodiment of the present invention, will be described.

The mixing unit 828 performs alpha blending on an R signal r₁ at an arbitrary location in the first RGB image and on an R signal r₂ at the same location as the location of the R signal r₁ in the second RGB image, using the following Equation 1, and calculates a final RGB image signal R_{f}.

R_{f}=α×r₁+(1−α)×r₂

G_{f}=α×g₁+(1−α)×g₂

B_{f}=α×b₁+(1−α)×b₂ (1)

Also, like the R signals r₁ and r₂, the mixing unit 828 performs alpha blending on G and B signals g₁ and b₁ at arbitrary locations in the first RGB image, and on G and B signals g₂ and b₂ at the same locations in the second RGB image as those of the G and B signals g₁ and b₁ in the first RGB image, using the above Equation 1, and calculates final RGB image signals G_{f} and B_{f}.

The third RGB storage unit 830 outputs the final RGB images R_{f}, G_{f}, and B_{f} output from the mixing unit 828 to the RGB encoding unit 840.

The third RGB storage unit 830 may be, for example, but not limited to, an SDRAM, a DDR SDRAM, a DDR2 SDRAM, a SRAM, or a register. Also, the third RGB storage unit 830 may be, for example, but not limited to, a non-volatile memory such as a hard disc or a flash memory.

The RGB encoding unit 840 receives, encodes, and outputs the final RGB signals. The RGB encoding unit 840 is illustrated in FIG. 3 and accordingly a detailed description thereof will be omitted.

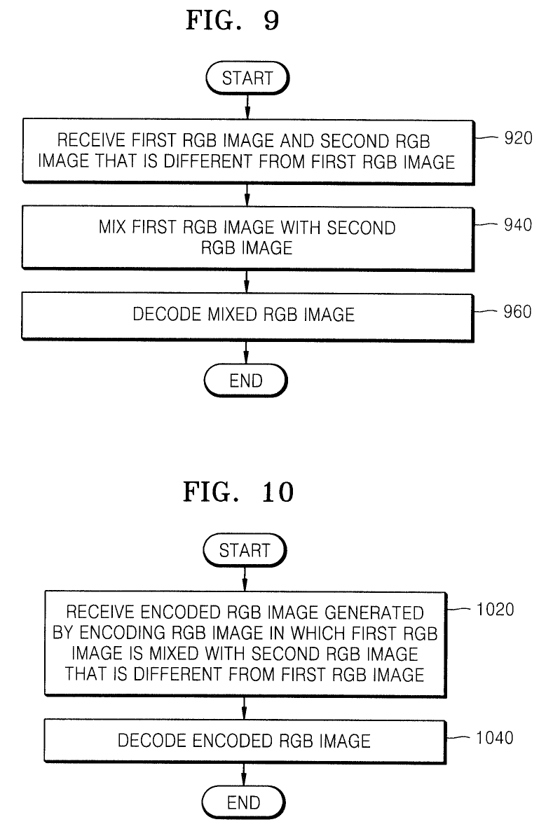

FIG. 9 is a flowchart illustrating an RGB image encoding method according to another exemplary embodiment of the present invention, which is performed by the RGB image encoding apparatus illustrated in FIG. 8.

In operation 920, a first RGB image and a second RGB image which is different from the first RGB image are received and stored. If the first RGB image is an analog RGB image, the first RGB image is stored in the form of RGB without any format conversion, via an analog interface. Also, if the first RGB image is a digital RGB image, the first RGB image is stored in the form of RGB without any format conversion, via a digital interface. The second RGB image can be stored in the same manner as that applied to the first RGB image.

In operation 940, the first RGB image and the second RGB image are mixed. In the exemplary embodiment, alpha blending is performed on R, G, and B signals r₁, g₁, and b₁ at arbitrary locations in the first RGB image and on R, G, and B signals r₂, g₂, and b₂ at the same locations in the second RGB image as those of the R, G, and B signals r₁, g₁, and b₁ in the first RGB image, using the above equation 1, so that final RGB image signals are calculated.

In operation 960, the mixed RGB images are encoded.

Hereinafter, an RGB image decoding method corresponding to the RGB image encoding method illustrated in FIG. 8 will be described with reference to the RGB image decoding apparatus illustrated in FIG. 5. The RGB image decoding apparatus has the same configuration as the RGB image decoding apparatus illustrated in FIG. 5, except that the RGB decoding unit illustrated in FIG. 5 receives an encoded RGB image obtained by encoding an RGB image in which a first RGB image is mixed with a second RGB image that is different from the first RGB image, and decodes the encoded RGB image, and accordingly, a detailed description thereof will be omitted. The RGB image decoding apparatus according to the other exemplary embodiment of the present invention may also further include a de-mixing unit (not shown) de-mixing the decoded RGB image and generating a restored first RGB image and a restored second RGB image. The de-mixing unit may be located in front of or behind the RGB image storage unit 542.

FIG. 10 is a flowchart illustrating an RGB decoding method corresponding to the RGB image encoding method illustrated in FIG. 9.

In operation 1020, an encoded RGB image generated by encoding an RGB image in which a first RGB image is mixed with a second RGB image that is different from the first RGB image is received.

In operation 1040, the encoded RGB image is decoded. Selectively, the encoded RGB image can be de-mixed so that the first RGB image and the second RGB image are restored.

The invention can also be embodied as computer readable codes on a computer readable recording medium. The computer readable recording medium is any data storage device that can store data which can be thereafter read by a computer system. Examples of the computer readable recording medium include, but are not limited to, read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

As described above, since an RGB encoding method according to the present invention performs encoding and decoding without any color format conversion, no deterioration in picture quality occurs. Also, since an image that is to be displayed is reproduced using an RGB decoding unit on a decoding side by mixing and encoding two or more different RGB images, it is possible to reduce the amount of transmission data and simplify the configuration of a decoding apparatus.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A method of encoding an RGB image, the method comprising:
receiving and storing the RGB image; and
performing RGB-encoding on the RGB image,
wherein the RGB-encoding comprises performing intra prediction or inter prediction for encoding a current image based on a previous RGB image.

2. A method of RGB-encoding of an RGB image, method comprising:
mixing a first RGB image with a second RGB image which is different from the first RGB image, and generating a mixed RGB image; and
performing RGB-encoding on the mixed RGB image,
wherein the RGB-encoding comprises performing intra prediction or inter prediction for encoding the current image based on a previous RGB image.

3. The method of claim 2, wherein the first RGB image is an analog RGB image or a digital RGB image, and the second RGB image is an On Screen Display (OSD) image.

4. The method of claim 2, further comprising:
storing the first RGB image;
storing the second RGB image; and
storing the mixed RGB image.

5. The method of claim 2, wherein the mixing of the first RGB image with the second RGB image is performed according to the equation
R_{f}=αx r₁+(1-α) x r₂
G_{f}=αx g₁+(1-α) x g₂
B_{f}=αx b₁+(1-α) x b₂
where R_{f}, G_{f}, and B_{f} are red (R), green (G), and blue (B) signals of a final RGB signal, respectively, rₗ, gₗ, and b₁ are R, G, and B signals at arbitrary locations in the first RGB signal, respectively, and r₂, g₂, and b₂ are R, G, and B signals at locations corresponding to locations of the rₗ, gₗ, and b₁ of the first RGB signal in the second RGB signal, respectively.

6. An apparatus for encoding an RGB image, the apparatus comprising:
a storage unit which stores an input RGB image; and
an RGB encoding unit which performs RGB encoding on the stored RGB image,
wherein the RGB encoding unit comprises an inter or intra prediction unit performing inter prediction and intra prediction for encoding a current image based on a previous RGB image.

7. An encoding apparatus for encoding an RGB image, the encoding apparatus comprising:
a mixing unit which mixes an input first RGB image with a second RGB image which is different from the first RGB image; and
an RGB encoding unit which encodes the mixed RGB image,
wherein the RGB encoding unit comprises an inter or intra prediction unit which performs inter prediction or intra prediction for encoding a current image based on a previous RGB image.

8. The encoding apparatus of claim 7, wherein the input first RGB image is an analog RGB image or a digital RGB image, and the second RGB image is an On Screen Display (OSD) image.

9. The encoding apparatus of claim 7, further comprising:
a first RGB storage unit which stores the first RGB image;
a second RGB storage unit which stores the second RGB image; and
a third RGB storage unit which stores the mixed RGB image.

10. The encoding apparatus of claim 7, wherein the mixing unit mixes the input first RGB image with the second RGB image according to the equation:
R_{f}=αx r₁+(1-α) x r₂
G_{f}=αx g₁+(1-α) x g₂
B_{f}=αx b₁+(1-α) x b₂
where R_{f}, G_{f}, and B_{f} represent R, G, and B signals of a final RGB image, respectively, rₗ, gₗ, and b₁ represents red (R), green (G), and blue (B) signals at arbitrary locations of the first RGB image, respectively, and r₂, g₂, and b₂ represent R, G, and B signals of the second RGB image at locations corresponding to the locations of the R, G, and B signals rₗ, gₗ, and b₁ of the first RGB image, respectively.

11. A method of decoding an RGB image, the method comprising:
receiving an encoded RGB image;
decoding the received RGB image;
storing the decoded RGB image; and
performing inter prediction or intra prediction for decoding a current image based on a decoded previous RGB image.

12. A method of decoding an RGB image, the method comprising:
receiving an encoded RGB image generated by encoding an RGB image in which a first RGB image is mixed with a second RGB image which is different from the first RGB image;
decoding the encoded RGB image;
storing the decoded RGB image; and
performing inter prediction or intra prediction for decoding a current image based on a decoded previous RGB image.

13. The method of claim 12, wherein the first RGB image is an analog RGB image or a digital RGB image, and the second RGB image is an On Screen Display (OSD) image.

14. The method of claim 12, further comprising performing de-mixing on the decoded RGB image and generating a restored first RGB image and a restored second RGB image.

15. The method of claim 12, wherein the first RGB signal is mixed with the second RGB signal, according to the equation
R_{f}=αx r₁+(1-α) x r₂
G_{f}=αx g₁+(1-α) x g₂
B_{f}=αx b₁+(1-α) x b₂
where R_{f}, G_{f}, and B_{f} represent red (R), green (G), and blue (B) signals of a final RGB image, respectively, rₗ, gₗ, and b₁ represents R, G, and B signals at arbitrary locations of the first RGB image, respectively, and r₂, g₂, and b₂ represent R, G, and B signals of the second RGB image at locations corresponding to the locations of the R, G, and B signals rₗ, gₗ, and b₁ of the first RGB image, respectively.

16. An apparatus for decoding an RGB image, the apparatus comprising:
an RGB decoding unit which decodes an encoded RGB image which is received;
an RGB image storage unit which stores the decoded RGB image; and
an inter or intra prediction unit which performs inter prediction or intra prediction for decoding a current image based on a decoded previous RGB image.

17. An apparatus for decoding an RGB image, comprising:
an RGB decoding unit which decodes an encoded RGB image generated by encoding an RGB image in which a first RGB image is mixed with a second RGB image which is different form the first RGB image,
wherein the RGB decoding unit comprises an RGB image storage unit which stores the decoded RGB image; and
an inter or intra prediction unit which performs inter prediction or intra prediction for decoding a current image based on a decoded previous RGB image.

18. The apparatus of claim 17, wherein the received first RGB image is an analog RGB image or a digital RGB image, and the second RGB image is an On Screen Display (OSD) image.

19. The apparatus of claim 17, further comprising a de-mixing unit which performs de-mixing on the decoded RGB image and generates a restored first RGB image and a restored second RGB image.

20. The apparatus of claim 17, wherein the first RGB signal is mixed with the second RGB signal, according to the equation
R_{f}=αx r₁+(1-α) x r₂
G_{f}=αx g₁+(1-α) x g₂
B_{f}=αx b₁+(1-α) x b₂
where R_{f}, G_{f}, and B_{f} represent red (R), green (G), and blue (B) signals of a final RGB image, respectively, rₗ, gₗ, and b₁ represents R, G, and B signals at arbitrary locations of the first RGB image, respectively, and r₂, g₂, and b₂ represent R, G, and B signals of the second RGB image at locations corresponding to the locations of the R, G, and B signals rₗ, gₗ, and b₁ of the first RGB image, respectively.

21. A computer-readable recording medium having embodied thereon instructions for causing a device to execute an RGB image encoding method, the method comprising:
receiving and storing an RGB image; and
performing RGB-encoding on the RGB image,
wherein the RGB-encoding of the RGB image comprises performing intra prediction or inter prediction for encoding a current image based on a previous RGB image.

22. A computer-readable recording medium having embodied thereon instructions for causing a device to execute an RGB image encoding method, the method comprising:
receiving a first RGB image, mixing the first RGB image with a second RGB image which is different from the first RGB image, and generating a mixed RGB image; and
performing RGB-encoding on the mixed RGB image,
wherein the RGB-encoding of the mixed RGB image comprises performing at least one of intra prediction and inter prediction for encoding a current image based on a previous RGB image.

23. A computer-readable recording medium having embodied thereon instructions for causing a device to execute an RGB image decoding method, the method comprising:
receiving an encoded RGB image;
decoding the RGB image;
storing the decoded RGB image; and
performing at least one of inter prediction and intra prediction for decoding a current image based on a decoded previous RGB image.

24. A computer-readable recording medium having embodied thereon instructions for causing a device to execute an RGB image decoding method, the method comprising:
receiving an encoded RGB image generated by encoding an RGB image in which a first RGB image is mixed with a second RGB image which is different from the first RGB image;
decoding the encoded RGB image;
storing the decoded RGB image; and
performing inter prediction or intra prediction for decoding a current image based on decoded previous RGB image.
